(19) United States
(12) Patent Application Publication
(10) Pub. No.: US 2025/0238388 A1
(43) Pub. Date: Jul. 24, 2025

(54) DEVICE AND METHODS FOR SINGLE-CHIP PCIe VIRTUALIZATION

(71) Applicant: Microchip Technology Incorporated, Chandler, AZ (US)

(72) Inventors: John Stewart, Dripping Springs, TX (US); Josh Averyt, Chandler, AZ (US); Andrew Rogers, Tempe, AZ (US)

(73) Assignee: Microchip Technology Incorporated, Chandler, AZ (US)

(21) Appl. No.: 18/679,048

(22) Filed: May 30, 2024

Related U.S. Application Data
(60) Provisional application No. 63/622,719, filed on Jan. 19, 2024.

(51) Int. Cl. G06F 13/42; H04L 49/00

(52) U.S. Cl. CPC G06F 13/4221; G06F 2213/0026; H04L 49/70

(57) ABSTRACT

A switch may include one or more input ports, a forwarder, a virtualizer and one or more control units. The switch may receive a data packet at an input port and the forwarder may send the data packet to the virtualizer. The virtualizer may convert the data packet into a PCIe signal and may transmit the PCIe signal to the one or more control units.

### PRIORITY

This application claims priority to commonly owned U.S. Patent Application No. 63/622,719 filed Jan. 19, 2024, the entire contents of which are hereby incorporated by reference for all purposes.

### FIELD OF THE INVENTION

The present disclosure relates to a system and method for virtualization of endpoints in a Peripheral Component Interface Express (PCIe) network.

### BACKGROUND

One or more switches may control network traffic between endpoints. In one of various examples, a switch may be an Ethernet switch.

Ethernet switches have traditionally included a memory endpoint. Memory endpoints may include SRAM memory endpoints or other memory endpoints. In some examples, Ethernet switches may interface to Peripheral Component Interconnect Express (PCIe) endpoints. Ethernet switches supporting PCIe endpoints may additionally support virtualization. In one of various examples, virtualization may include single root virtualization (SR-IOV) endpoints. Such systems may include an additional PCIe root complex function to be implemented between the Ethernet switch and the PCIe endpoints. Such an additional PCIe root complex function adds latency to the system.

In one of various examples, a separate component may be inserted between the Ethernet switch and the one or more endpoints, the separate component to implement a root complex function. Such a separate root complex function adds additional complexity as the Ethernet switch now has an additional dependency on a separate PCIe Switch device to realize SR-IOV compliant virtualization.

There is a need for a system comprising a switch and a PCIe root complex function which reduces the latency and complexity associated with the use of a separate PCIe root complex function.

### SUMMARY

The examples herein enable a device, system and method for a single-chip system to implement PCIe virtualization.

According to one aspect, a switch includes one or more input ports, a forwarder coupled to the one or more input ports. The switch may include a virtualizer coupled to the forwarder and one or more output ports coupled to the virtualizer. In operation, the one or more input ports may receive at least one data packet and the forwarder may forward the data packet to the virtualizer. The virtualizer may convert the received data packets into PCIe signals and may transmit the PCIe signals on the one or more output ports.

According to one aspect, a system includes a switch. The switch may include one or more input ports and a forwarder coupled to the one or more input ports. The system may include a virtualizer coupled to the forwarder, one or more output ports coupled to the virtualizer, and one or more control units coupled to at least one of the one or more output ports. In operation, the one or more input ports may receive at least one data packet and the forwarder may forward the data packet to the virtualizer. The virtualizer may convert the received data packets into PCIe signals and may transmit the PCIe signals to the one or more control units over the one or more output ports.

According to one aspect, a method includes steps of: receiving a data packet at an input port of a switch, processing the received data at the switch, generating, in a virtualizer within the switch, a PCIe signal based on the received data, implementing, in the virtualizer within the switch, a root complex function to interface to one or more control units; and transmitting the PCIe signal to the one or more control units.

### BRIEF DESCRIPTION OF THE DRAWINGS

FIG. 1 illustrates one of various examples of a system including a switch and a separate root complex function according to the prior art.

FIG. 2 illustrates one of various examples of a switch with an integrated root complex function.

FIG. 3 illustrates a method transmitting data in a system with an integrated root complex function.

### DETAILED DESCRIPTION

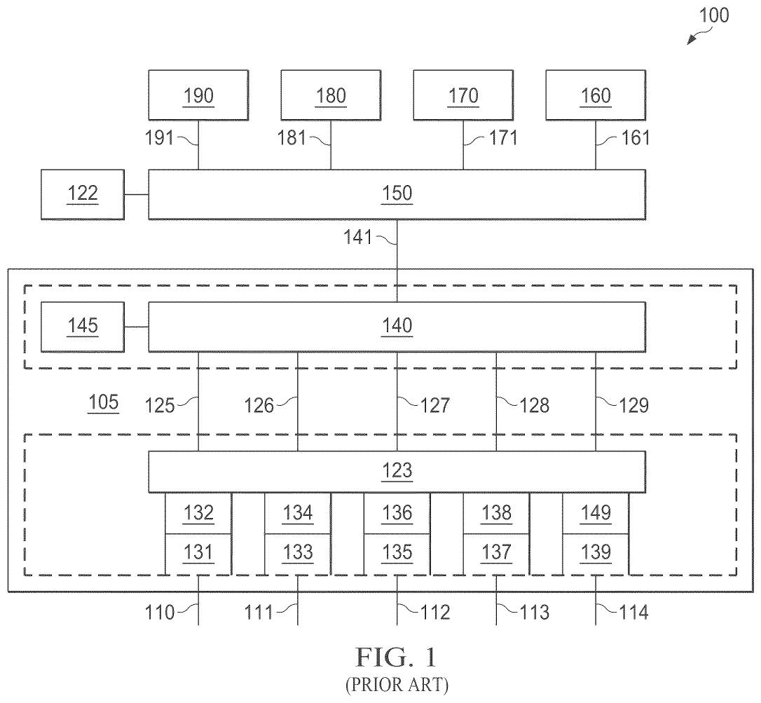

FIG. 1 illustrates one of various examples of a system 100 including a switch 105 and a separate root complex function according to the prior art. The example of FIG. 1 utilizes the term PHY to refer to the physical layer of a network connection and the term MAC to refer to the Media Access Control layer of a network connection.

System 100 may include switch 105. Switch 105 may be an Ethernet switch or may be another type of switch not specifically mentioned. Switch 105 may receive data at one or more input ports 110, 111, 112, 113, 114. Input ports 110, 111, 112, 113, 114 may receive Ethernet packets, or may receive another type of data not specifically mentioned. The example illustrated in FIG. 1 includes 5 input ports, 110, 111, 112, 113, and 114, but this is not intended to be limiting.

Input port 110 may be coupled to PHY 131. PHY 131 may be a physical layer and may include one or more circuits to receive data at input port 110. PHY 131 may include modulators, demodulators, encoders, decoders, drivers, amplifiers, equalizers, clock and data recovery circuits, synchronization circuits or other circuits not specifically mentioned. The output of PHY 131 may be input to MAC 132. MAC 132 may be a Media Access Control layer and may control frame synchronization, addressing, error checking, frame forwarding, and other operations not specifically mentioned. The output of MAC 132 may be coupled to forwarder 123.

Input port 111 may be coupled to PHY 133. PHY 133 may be a physical layer and may include one or more circuits to receive data at input port 111. PHY 133 may include modulators, demodulators, encoders, decoders, drivers, amplifiers, equalizers, clock and data recovery circuits, synchronization circuits or other circuits not specifically mentioned. The output of PHY 133 may be input to MAC 134. MAC 134 may be a Media Access Control layer and may control frame synchronization, addressing, error checking, frame forwarding, and other operations not specifically mentioned. The output of MAC 134 may be coupled to forwarder 123.

Input port 112 may be coupled to PHY 135. PHY 135 may be a physical layer and may include one or more circuits to receive data at input port 112. PHY 135 may include modulators, demodulators, encoders, decoders, drivers, amplifiers, equalizers, clock and data recovery circuits, synchronization circuits or other circuits not specifically mentioned. The output of PHY 135 may be input to MAC 136. MAC 136 may be a Media Access Control layer and may control frame synchronization, addressing, error checking, frame forwarding, and other operations not specifically mentioned. The output of MAC 136 may be coupled to forwarder 123.

Input port 113 may be coupled to PHY 137. PHY 137 may be a physical layer and may include one or more circuits to receive data at input port 113. PHY 137 may include modulators, demodulators, encoders, decoders, drivers, amplifiers, equalizers, clock and data recovery circuits, synchronization circuits or other circuits not specifically mentioned. The output of PHY 137 may be input to MAC 138. MAC 138 may be a Media Access Control layer and may control frame synchronization, addressing, error checking, frame forwarding, and other operations not specifically mentioned. The output of MAC 138 may be coupled to forwarder 123.

Input port 114 may be coupled to PHY 139. PHY 139 may be a physical layer and may include one or more circuits to receive data at input port 114. PHY 139 may include modulators, demodulators, encoders, decoders, drivers, amplifiers, equalizers, clock and data recovery circuits, synchronization circuits or other circuits not specifically mentioned. The output of PHY 139 may be input to MAC 149. MAC 149 may be a Media Access Control layer and may control frame synchronization, addressing, error checking, frame forwarding, and other operations not specifically mentioned. The output of MAC 149 may be coupled to forwarder 123.

Forwarder outputs 125, 126, 127, 128, 129 may be input to virtualizer 140. The example illustrated in FIG. 1 includes 5 outputs of forwarder 123, but this is not intended to be limiting. Forwarder 123 may have the same number of outputs as the number of input ports, or forwarder 123 may have a different number of outputs from the number of input ports.

Virtualizer 140 may convert forwarder outputs 125, 126, 127, 128, 129 into one or more PCIe transactions and may transmit the one or more PCIe transactions, when combined, as, for example, PCIe signal 141. PCIe signal 141 may contain data transactions according to the PCIe protocol. Controller 145 may control operation of virtualizer 140 and may sequence respective PCIe transaction on PCIe signal 141. PCIe signal 141 may be input to a discrete PCIe switch 150.

Discrete PCIe switch 150 may receive PCIe signal 141 from switch 105 and may generate PCIe signals 161, 171, 181, and 191, though this is not intended to be limiting. Other examples may include a different number of PCIe signals output from discrete PCIe switch 150.

In one of various examples, discrete PCIe switch 150 may generate PCIe signal 191, and PCIe signal 191 to be coupled to control unit 190. Control unit 190 may control operation of one or more systems. Control unit 190 may be an automotive control unit. As one of various examples, in an automotive application, control unit 190 may, without limitation, be an engine control unit. Discrete PCIe switch 150 may generate PCIe signal 181, and PCIe signal 181 to be coupled to control unit 180. Control unit 180 may control operation of one or more systems. Control unit 180 may be an automotive control unit. As one of various examples, in an automotive application, control unit 180 may, without limitation, be a driver assistance system. Discrete PCIe switch 150 may generate PCIe signal 171, and PCIe signal 171 to be coupled to control unit 170. Control unit 170 may control operation of one or more systems. Control unit 170 may be an automotive control unit. As one of various examples, in an automotive application, control unit 170 may, without limitation, be a battery management system. Discrete PCIe switch 150 may generate PCIe signal 161, and PCIe signal 161 to be coupled to control unit 160. Control unit 160 may control operation of one or more systems. Control unit 160 may be an automotive control unit. As one of various examples, in an automotive application, control unit 160 may, without limitation, be a safety system.

Discrete PCIe switch 150 may implement a root complex function. Discrete PCIe switch 150 may access memory 122.

Control unit 190 may include one or more circuits which may control one or more systems within a larger application. The larger application may be an automotive application, or may be another type of application not specifically mentioned. PCIe signal 191 may configure control unit 190, may send data to control unit 190 and may receive data from control unit 190.

Control unit 180 may include one or more circuits which may control one or more systems within a larger application. The larger application may be an automotive application, or may be another type of application not specifically mentioned. PCIe signal 181 may configure control unit 180, may send data to control unit 180 and may receive data from control unit 180.

Control unit 170 may include one or more circuits which may control one or more systems within a larger application. The larger application may be an automotive application, or may be another type of application not specifically mentioned. PCIe signal 171 may configure control unit 170, may send data to control unit 170 and may receive data from control unit 170.

Control unit 160 may include one or more circuits which may control one or more systems within a larger application. The larger application may be an automotive application, or may be another type of application not specifically mentioned. PCIe signal 161 may configure control unit 160, may send data to control unit 160 and may receive data from control unit 160.

The example illustrated in FIG. 1 includes 4 control units, but this is not intended to be limiting.

Switch 105 may include other components not explicitly shown in FIG. 1.

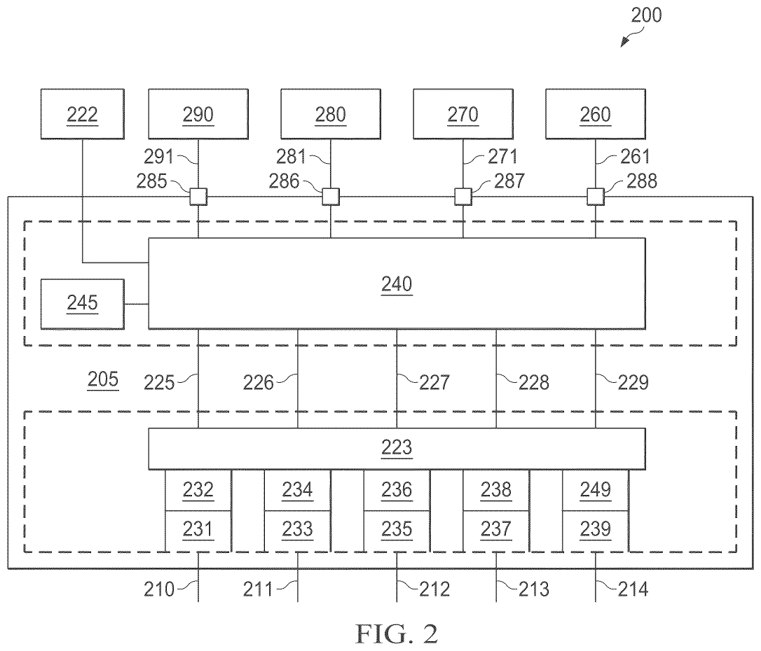

FIG. 2 illustrates one of various examples of a switch 205 with an integrated root complex function.

System 200 may include switch 205. Switch 205 may be an Ethernet switch or may be another type of switch not specifically mentioned. Switch 205 may receive data packets at one or more input ports 210, 211, 212, 213, 214. Input ports 210, 211, 212, 213, 214 may receive Ethernet packets, or may receive another type of packetized data not specifically mentioned. The example illustrated in FIG. 2 includes 5 input ports, but this is not intended to be limiting.

Input port 210 may be coupled to PHY 231. PHY 231 may be a physical layer and may include one or more circuits to receive data at input port 210. PHY 231 may include modulators, demodulators, encoders, decoders, drivers, amplifiers, equalizers, clock and data recovery circuits, synchronization circuits or other circuits not specifically mentioned. The output of PHY 231 may be input to MAC 232. MAC 232 may be a Media Access Control layer and may control frame synchronization, addressing, error checking, frame forwarding, and other operations not specifically mentioned. The output of MAC 232 may be coupled to forwarder 223.

Input port 211 may be coupled to PHY 233. PHY 233 may be a physical layer and may include one or more circuits to receive data at input port 211. PHY 233 may include modulators, demodulators, encoders, decoders, drivers, amplifiers, equalizers, clock and data recovery circuits, synchronization circuits or other circuits not specifically mentioned. The output of PHY 233 may be input to MAC 234. MAC 234 may be a Media Access Control layer and may control frame synchronization, addressing, error checking, frame forwarding, and other operations not specifically mentioned. The output of MAC 234 may be coupled to forwarder 223.

Input port 212 may be coupled to PHY 235. PHY 235 may be a physical layer and may include one or more circuits to receive data at input port 212. PHY 235 may include modulators, demodulators, encoders, decoders, drivers, amplifiers, equalizers, clock and data recovery circuits, synchronization circuits or other circuits not specifically mentioned. The output of PHY 235 may be input to MAC 236. MAC 236 may be a Media Access Control layer and may control frame synchronization, addressing, error checking, frame forwarding, and other operations not specifically mentioned. The output of MAC 236 may be coupled to forwarder 223.

Input port 213 may be coupled to PHY 237. PHY 237 may be a physical layer and may include one or more circuits to receive data at input port 213. PHY 237 may include modulators, demodulators, encoders, decoders, drivers, amplifiers, equalizers, clock and data recovery circuits, synchronization circuits or other circuits not specifically mentioned. The output of PHY 237 may be input to MAC 238. MAC 238 may be a Media Access Control layer and may control frame synchronization, addressing, error checking, frame forwarding, and other operations not specifically mentioned. The output of MAC 238 may be coupled to forwarder 223.

Input port 214 may be coupled to PHY 239. PHY 239 may be a physical layer and may include one or more circuits to receive data at input port 214. PHY 239 may include modulators, demodulators, encoders, decoders, drivers, amplifiers, equalizers, clock and data recovery circuits, synchronization circuits or other circuits not specifically mentioned. The output of PHY 239 may be input to MAC 249. MAC 249 may be a Media Access Control layer and may control frame synchronization, addressing, error checking, frame forwarding, and other operations not specifically mentioned. The output of MAC 249 may be coupled to forwarder 223.

Forwarder outputs 225, 226, 227, 228, 229 may be input to virtualizer 240. The example illustrated in FIG. 2 includes 5 outputs of forwarder 223, but this is not intended to be limiting. Forwarder 223 may have the same number of outputs as the number of input ports, or forwarder 223 may have a different number of outputs from the number of input ports.

Virtualizer 240 may convert forwarder outputs 225, 226, 227, 228, 229 into PCIe transactions and may transmit PCIe transactions over PCIe signals 291, 281, 271, 261. PCIe signals 291, 281, 271 and 261 may contain data transmission according to the PCIe protocol. PCIe signal 291 may be transmitted over output port 285. PCIe signal 281 may be transmitted over output port 286. PCIe signal 271 may be transmitted over output port 287. PCIe signal 261 may be transmitted over output port 288. Controller 245 may control operation of virtualizer 240 and may sequence transmission of PCIe transactions on PCIe signals 291, 281, 271, 261.

Virtualizer 240 may implement a root complex function to convert forwarder outputs 225, 226, 227, 228, 229 into PCIe transactions. Virtualizer 240 may generate PCIe transactions and may transmit PCIe transactions over PCIe signals to at least one of control units 260, 270, 280, 290. Virtualizer 240 may enable control units 260, 270, 280 and 290 to function as endpoints in a single-root virtualization (SR-IOV) network.

Virtualizer 240 may include circuitry to enable switch 205 to communicate with multiple endpoints utilizing a PCIe protocol. In the example illustrated in FIG. 2, control units 290, 280, 270, 260 may comprise endpoints.

In one of various examples, virtualizer 240 may transmit PCIe signal 291, PCIe signal 291 to be coupled to control unit 290. Control unit 290 may control operation of one or more systems. Control unit 290 may be an automotive control unit. As one of various examples, in an automotive application, control unit 290 may be an engine control unit. Virtualizer 240 may transmit PCIe signal 281, PCIe signal 281 to be coupled to control unit 280. Control unit 280 may control operation of one or more systems. Control unit 280 may be an automotive control unit. As one of various examples, in an automotive application, control unit 290 may be a driver assistance system. Virtualizer 240 may transmit PCIe signal 271, PCIe signal 271 to be coupled to control unit 270. Control unit 270 may control operation of one or more systems. Control unit may be an automotive control unit. As one of various examples, in an automotive application, control unit 270 may be a battery management system. Virtualizer 240 may transmit PCIe signal 261 to control unit 260. Control unit 260 may control operation of one or more systems. Control unit 260 may be an automotive control unit. As one of various examples, in an automotive application, control unit 260 may, without limitation, be a safety system. Switch 205 may access memory 222.

In combination, control unit 260, control unit 270, control unit 280 and control unit 290 may be part of an automotive customer zonal network.

In one of various examples, control unit 290 may include one or more circuits which may control one or more systems within an automotive application. PCIe signal 291 may configure control unit 290, may send data to control unit 290 and may transmit data from control unit 290.

In one of various examples, control unit 280 may include one or more circuits which may control one or more systems within an automotive application. PCIe signal 281 may configure control unit 280, may send data to control unit 280 and may transmit data from control unit 280.

In one of various examples, control unit 270 may include one or more circuits which may control one or more systems within an automotive application. PCIe signal 271 may configure control unit 270, may send data to control unit 270 and may transmit data from control unit 270.

In one of various examples, control unit 260 may include one or more circuits which may control one or more systems within an automotive application. PCIe signal 261 may configure control unit 260, may send data to control unit 260 and may transmit data from control unit 260.

Switch 205 may implement a root complex function within virtualizer 240 and may eliminate a discrete PCIe switch, as described and illustrated in reference to FIG. 1.

The example illustrated in FIG. 2 includes 4 control units, but this is not intended to be limiting.

Switch 205 may include virtualizer 240, forwarder 223, PHYs 231, 233, 235, 237 239 and MACs 232, 234, 236, 238 and 249 and may be a single silicon device. Switch 205 may include other components not explicitly shown in FIG. 2.

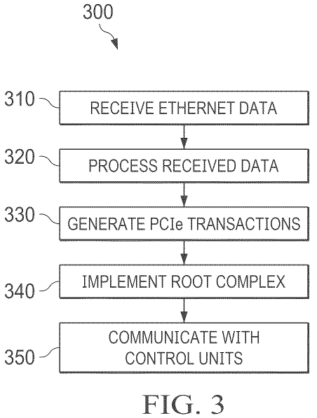

FIG. 3 illustrates a method transmitting data in a system with an integrated root complex function.

At operation 310, at least one packet of packetized data may be received at a switch.

At operation 320, the received data may be processed by the switch. Processing may include forwarding received data to a virtualizer.

At operation 330, a virtualizer in the switch may generate PCIe signals based on the received data.

At operation 340, a root complex function may be implemented at the virtualizer, the root complex function to provide an interface between the switch and one or more control units.

At operation 350, the virtualizer may communicate with one or more control units, the communication based on the generated PCIe signals.

1. A switch comprising:
one or more input ports;
a forwarder coupled to the one or more input ports;
a virtualizer coupled to the forwarder; and
one or more output ports coupled to the virtualizer,
wherein the one or more input ports to receive at least one data packet, the forwarder to forward the received at least one data packet to the virtualizer, and the virtualizer to convert the received at least one data packet into PCIe signals and to transmit the PCIe signals on the one or more output ports.

2. The switch as claimed in claim 1, the virtualizer to implement a PCIe root complex function.

3. The switch as claimed in claim 1, the at least one data packet comprising an Ethernet packet.

4. The switch as claimed in claim 1, the one or more input ports coupled to a physical layer (PHY) and a media access control (MAC) circuit.

5. The switch as claimed in claim 1, the one or more output ports coupled to one or more control units.

6. A system comprising:
a switch comprising:
one or more input ports;
a forwarder coupled to the one or more input ports;
a virtualizer coupled to the forwarder;
one or more output ports coupled to the virtualizer; and
one or more control units coupled to at least one of the one or more output ports; and
wherein the one or more input ports to receive at least one data packet, the forwarder to forward the received at least one data packet to the virtualizer, and the virtualizer to convert the received at least one data packet into one or more PCIe signals and to transmit the one or more PCIe signals to the one or more control units over the one or more output ports.

7. The system as claimed in claim 6, the virtualizer to implement a root complex function.

8. The system as claimed in claim 6, at least one of the one or more control units comprising an automotive control unit.

9. The system as claimed in claim 6, the one or more control units comprising an Automotive Customer Zonal Network.

10. The system as claimed in claim 6, the one or more control units comprising a single-root virtualization (SR-IOV) endpoint.

11. A method comprising:
receiving a data packet at an input port of a switch;
processing the received data at the switch;
generating, in a virtualizer within the switch, a PCIe signal based on the received data;
implementing, in the virtualizer within the switch, a root complex function to interface to one or more control units; and
transmitting the PCIe signal to the one or more control units.

12. The method as claimed in claim 11, at least one of the one or more control units comprising an automotive control unit.

13. The method as claimed in claim 11, the one or more control units comprising an Automotive Customer Zonal Network.

14. The method as claimed in claim 11, the one or more control units comprising a single-root virtualization (SR-IOV) endpoint.
